(19) United States
(12) Patent Application Publication
(10) Pub. No.: US 2013/0163028 A1
(43) Pub. Date: Jun. 27, 2013

(54) ACCESSING CURRENT DATA BY USING CODE IMAGES

(71) Applicants: UDO KLEIN, Maximiliansau (DE); RUEDIGER EICHIN, Heidelberg (DE)

(72) Inventors: UDO KLEIN, Maximiliansau (DE); RUEDIGER EICHIN, Heidelberg (DE)

(21) Appl. No.: 13/335,940

(22) Filed: Dec. 23, 2011

(51) Int. Cl. G06K 15/00

(52) U.S. Cl. 358/1.14

(57) ABSTRACT

Techniques for accessing current data by using code images are described herein. In one aspect, a unique reference is generated in a computer system to a set of report parameters, and transformed to a scannable code image embedded in a document. In further aspect, the code image embedded in the document is captured at a smart device. A scanned copy of the code image or the extracted reference contained by the code image is sent to the computer system. A data report created based on the set of report parameters is executed in response to the receiving of the reference. In yet another aspect, the result from the execution of the data report is exposed to a consumer through an indicated output channel.

### BACKGROUND

The production and maintenance of various types of data reports is an important activity for practically every enterprise or organization. Typically, the complexity and the importance of data reporting in a company is proportionate to the size of the company, and as a result, to the complexity of its business processes. Very often, the success and even the existence of the organizations depend on their ability to produce timely, robust data reports. From certain perspective, the data reports could be explained as snapshots of the companies at particular moments in time based on predefined criteria to serve different purposes. For example, some data reports are created to provide a basis for taking management decisions. Such reports may provide information regarding the state of various parameters, such as, performance, liquidity, position on the market, etc. Further, there are numerous mandatory statutory reports that the organizations, profitable or non-profitable, have to provide regarding their status and activities.

Often, the people or organizational units engaged in creating data reports are not the consumers of the generated information. For example, an assistant may create a report for an executive. There are different forms for presenting the results of the generated data reports to the consumers. For example, the results may be sent in electronic format, printed on paper, etc. Usually, for the time between preparing a report and its actual usage or consumption, the reported information may become outdated. Further, the consumer may request additional data based on the reported information. Such situation would require executing the data report again to receive the most up-to-date information. The original report may have to be modified to extract the additional data requested, etc. However, there are urgent situations where there is not enough time, or where it is not convenient to generate the new reports, e.g., during executive's meeting, when analyzing data with high volatility, etc.

### SUMMARY

Various embodiments of systems and methods for accessing current data by using code images are described herein. A data report is created in a computer system based on a set of report parameters. According to one embodiment, in one aspect, a unique reference is generated to the set of report parameters. The unique reference is included in a code image. The code image is embedded in a document containing a result of an execution of the data report. The document is sent to a consumer of the reported results. According to another aspect, the code image embedded in the document is captured by a smart device. A scanned copy of the code image or the extracted reference contained by the code image is sent to the computer system. The data report is executed based on the referenced report parameters. According to yet another aspect, the result from the execution of the data report including current data is exposed to the consumer through an indicated output channel.

These and other benefits and features of the embodiments will be apparent upon consideration of the following detailed description of preferred embodiments thereof, presented in connection with the following drawings.

### BRIEF DESCRIPTION OF THE DRAWINGS

The claims set forth the scope with particularity. The embodiments are illustrated by way of example and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a solution for providing access to current data based on previously generated reports, according to one embodiment.

FIG. 2 is a flow diagram illustrating a process for augmenting a document with a reference to report parameters, according to one embodiment.

FIG. 3 is a flow diagram illustrating a process for accessing current data associated with a data report by using embedded code images, according to one embodiment.

FIG. 4 is a block diagram illustrating a computer system landscape where a solution for accessing current data by using code images is implemented, according to one embodiment.

FIG. 5 is a block diagram illustrating a computer system landscape where access to current data by using code images is implemented, according to one embodiment.

FIG. 6 is a block diagram of an exemplary computer system to execute computer readable instructions for accessing current data by using code images, according to one embodiment.

### DETAILED DESCRIPTION

Embodiments of techniques for accessing current data by using code images are described herein. In the following description, numerous specific details are set forth to provide a thorough understanding of the embodiments. One skilled in the relevant art will recognize, however, that the presented ideas can be practiced without one or more of the specific details, or with other methods, components, materials, etc. In other instances, well-known structures, materials, or operations are not shown or described in detail to avoid obscuring.

Reference throughout this specification to “one embodiment”, “this embodiment” and similar phrases, means that a particular feature, structure, or characteristic described in connection with the embodiment is included in at least one embodiment. Thus, the appearances of these phrases in various places throughout this specification are not necessarily all referring to the same embodiment. Furthermore, the particular features, structures, or characteristics may be combined in any suitable manner in one or more embodiments.

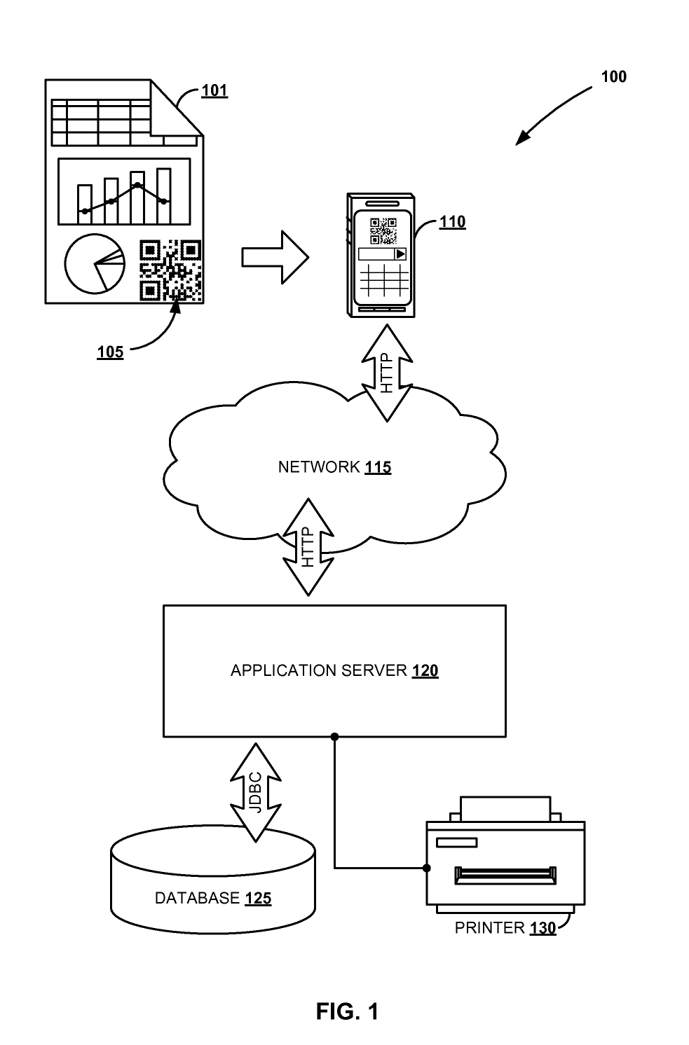

According to an exemplary scenario, a data report for a state of a company may be created in the company's computer system by a responsible user. The report is then printed out on paper to be presented during a management meeting. However, during the period between the generation of the report and the meeting, the reported state of the company may change. Further, during the meeting, additional data and/or various data analyses and drilldowns may be required in relation to the reported information. FIG. 1 shows an exemplary solution 100 for providing access to current data of an organization based on previously generated reports, according to one embodiment. Document 101 could be a printout of a data report generated for the organization. For example, the report printed as document 101 may be created and executed in application server 120. The document 101 may include data extracted from database 125 which is in communication with application server 120, e.g., through Java DataBase Connectivity (JDBC) interface. Further, the document may be printed on printer 130 connected to the application server 120.

Once printed, the document 101 contains information for a state of the organization at a particular moment in time. When up-to-date information is necessary, instead of executing and printing the report again, a direct access to the current data may be provided through smart device 110, according to one embodiment. The smart device 110 may be any client device having sufficient hardware and software functionality to access data on application server 120 via network 115. e.g., having at least a processor coupled to a memory storing executable instructions. For example, a list of such smart devices may include but is not limited to mobile phones, tablet computers, laptops, personal computers, computer terminals, etc. An additional requirement for the smart device 110 is to be able to pick up code image 105 included in the document 101.In one embodiment, the code image 105 stores a reference to the data used for generating the report document 101. For example, the code image 105 may contain Uniform Resource Locator (URL) that points to a Webpage containing up-to-date version of the report printed on document 101.

In one embodiment, the code image 105 is a graphical representation of a reference to one or more parameters used to generate the report. There are numerous variants of graphical representation of information suitable for scanning and reading by machines, e.g., bar codes, Quick Reference (QR) codes, etc. The techniques described herein are not limited by the type of code images. The smart device 110 may be used to scan the picture code 105, e.g., by using built-in or attached camera. The scanned code image may be read or decoded directly on the smart device, or it can be sent to the application server for recognition. In one embodiment, the code image 105 may be a plain text representation of the reference, e.g., the URL address that can be either automatically picked up, e.g., read by an application for Optical Character Recognition (OCR), or can be simply typed into the smart device 110 by a user. However, typing or using OCR application is inefficient and prone to errors. Therefore, graphical codes, like the QR codes, are better suited for providing access to the current data available at the computer systems of a company. In one embodiment, the document 101 may be augmented with the reference represented using different technology, e.g., a Radio-Frequency Identification (RFID) tag physically embedded in the printed document 101, recorded on a magnetic stripe or lamination adhered to the document, etc.

According to FIG. 1, the print out 101 of a report is augmented with a code image 105 containing reference to a set of parameters based on which the report is generated. For example, the reference may contain the URL of a Webpage corresponding to the report parameters. In one embodiment, the code image 105 may further include values of the set of parameters with which the report was executed before printing. Thus, a user who is interested in accessing the current state of the data included in the document 101 may simply point out the camera of the smart device 110 at the document 101 to pick-up the code image 105. An application running on the smart device 110 may recognize or “decode” the reference, e.g., the URL, contained in the code image, and may use it to directly access the updated report data. The data may be automatically extracted from the database 125. In one embodiment, the communication between the smart device and application server 120 is enabled via Internet or intranet network 115 using standard data exchange protocol, such as Hypertext Transfer Protocol (HTTP).

The current or up-to-date data may be displayed directly on the screen of the smart device 110. In one embodiment, the user may provide additional parameters to modify the reported data. For example, by using links or different functions available on the referenced Webpage, additional data may be extracted to complement the report, or various analyses and/or drilldowns may be performed. Thus, based on simple printout 101 augmented with code image 105, a user may request direct access to online or current data reports, focused analytical functionalities, and even to relevant data processing functions.

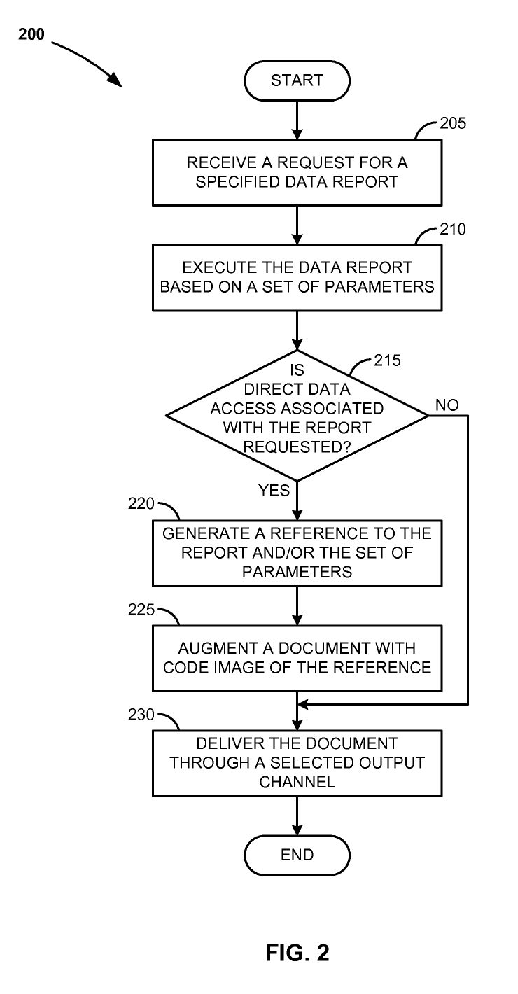

FIG. 2 shows process 200 for augmenting a document with a reference to parameters of a report created in a computer system environment, according to one embodiment. Process 200 starts with receiving a request for the data report, at 205. In one embodiment, the data report may be already specified, e.g., developed in the computer system environment. In another embodiment, the request may specify the information that should be extracted, e.g., by a number of report parameters. The report parameters may also specify various types of processing to be applied to the extracted data, such as, but not limited to calculating tendencies, totals, medians, finding relationships, etc. The report parameters may also specify the way the extracted data should be presented, e.g., table-like, pivotal views, various types of diagrams, etc. In one embodiment, a number of values are assigned to the set of report parameters, e.g. to be used in data query clauses, calculation formulas, report data layouts, etc.

At 210, the requested data report is executed based on the set of parameters. The execution of the report includes extracting the data necessary for the report. The data may be extracted from a database. In one embodiment, data may be extracted by other computer systems using various interfaces, e.g., Application Programming Interface (API), Web services interface, etc. Further, the extracted data may be processed according to the set of parameters. In one embodiment, the data report is executed based on one or more values assigned to the set of report parameters.

At 215, a check is performed to determine whether direct data access associated with the requested report is specified, e.g., requested. There are various ways to specify whether access to the up-to-date data associated with the report should be provided. For example, it may depend on the type of the data report, or the type of the reported data. In one embodiment, a user may predefine the data reports for which such access should be ensured. The request for direct access to current data may be part of, or provided in relation with the original data request received at 205.

When access to the current data is to be provided, process 200 continues at 220 with generating a reference to the report, e.g., a URL where the report with the requested information is available online Alternatively, or in addition to this, the reference may point to the set of parameters specifying the report. In one embodiment, the reference may include default or current values for one or more of the report parameters. At 225, a document is augmented with a code image of the reference. In one embodiment, the code image may be a printable representation of the reference, e.g., QR code. Alternatively, the reference may be included in various optical or/and non-optical tags or labels, e.g., optical storage media, RFID tags, magnetic stripes, etc. These tags or labels may be physically embedded or attached to the document at 225. In one embodiment, the reference is used to augment an electronic document, e.g., a Microsoft® Word® (MSWord®) document, Adobe® Portable Document Format (PDF) document, etc., where a picture of the code image of the reference is included.

In one embodiment, the document augmented with the code image of the report reference contains at least partially the requested data report. Thus, only part of the requested data may be printed out, while the rest of it may be accessed by using the reference embedded in the provided document. This technique may save time, e.g. by directly linking a smart device to a Webpage containing the full report. Further, it may reduce the turnover of paper documents by printing only a part of the requested data report. At 230, the document augmented with the code image of the reference is delivered to the consumer through a selected output channel. For example, the report may be delivered through a printer in a paper form. Electronic documents may be delivered as attachments to email messages, or by placing them at a specified location in the company's file system.

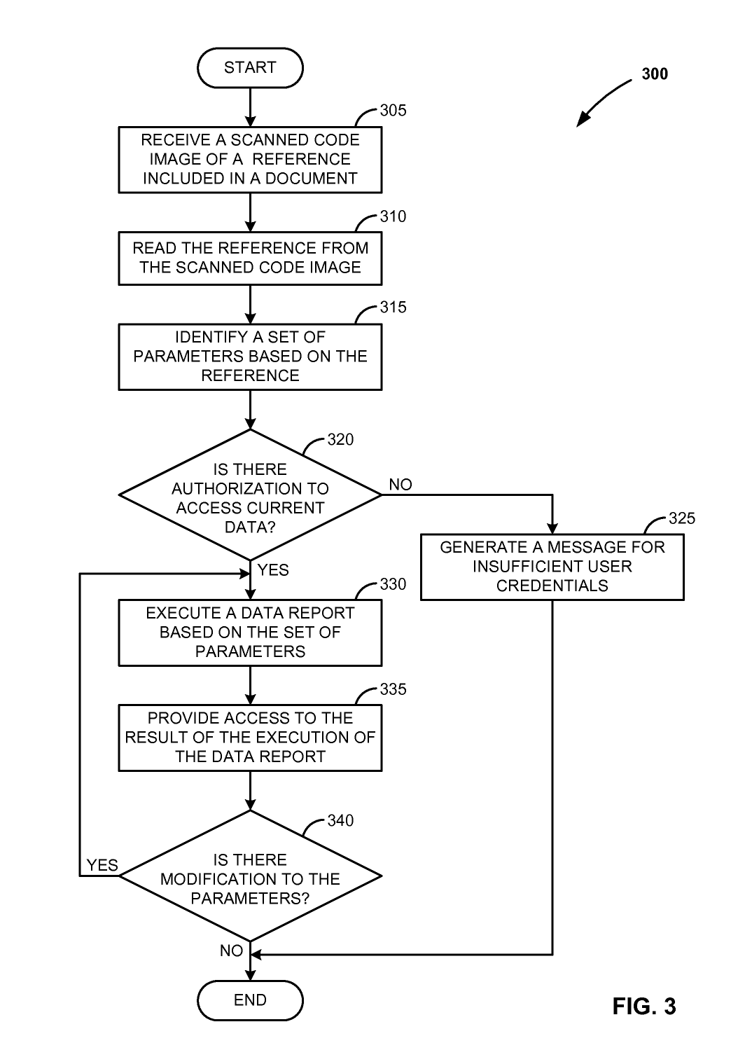

FIG. 3 shows process 300 for accessing current data associated with a data report by using embedded code images, according to one embodiment. At 305, an application receives a scanned code image of a reference included in a document. In one embodiment, the application runs on a smart device, and the code image of the reference is scanned by a peripheral equipment of the smart device, e.g., built in or attached camera, Dacuda® mouse, scanner, RFID reader, etc. Alternatively, the application may run on a server system (e.g., application server) while the scanned code image may still be captured and delivered using smart device. In one embodiment, the code image is embedded in an electronic document accessed by the application, e.g., at a corresponding database or file system. The code image may be extracted or read from such electronic document directly by the application or by using separate functionality or service available at the smart device or at the application server.

At 310, the reference contained in the scanned image is read by the receiving application. In one embodiment, the receiving application may be a general application, e.g., mobile app, developed to read particular type or types of code images captured or scanned with a particular type of built-in or/and plugged-in equipment, e.g., camera, scanner, etc. Such general purpose applications may be used simply as a service available internally or externally (e.g., as a Web service) at the smart device or/and at the application server. Alternatively, the reference stored in the code image may be read by an application running on the smart device or on the application server (or servers in case of distributed computer system environment), specifically developed to access the current report data associated with the reference.

A set of parameters or at least one parameter of the set of parameters is identified at 315 based on the reference extracted from the code image. In one embodiment, the reference is a pointer to the set of parameters stored in a computer system, e.g., in an object, database table, resource file, etc. In one embodiment, the set of parameters is associated with a referenced Webpage, e.g., when the reference is an URL. Further, the parameter or set of parameters for a particular data report may be included directly in the reference. According to one embodiment, the reference may contain one or more default values for one or more of the referenced parameters. The default values may be used to configure the data report for accessing particular data. For example, the set of parameters or the Webpage may correspond to a more general data report, and the default values may be used to extract particular segments of information, e.g., for particular customers, particular products, particular accounts, etc.

In one embodiment, the access to current data is granted only to users with sufficient credentials. For example, the user of the smart device may be associated with a specified level of privileges in the computer system (e.g., application server or servers) where the current data should be exposed. The current user credentials may be submitted automatically or manually with the activation of the smart device, or, together with the scanned code image or the extracted reference. At 320, a check is performed to verify whether the user of the smart device, or the smart device itself, has authorization to access the current data associated with the code image. If the privileges are insufficient, a message may be generated at 325 informing of the insufficient user credentials to access the data.

Once the rights of the user or smart device to access current data associated with the reference are confirmed at 320, a data report is executed at 330 based on the set of parameters provided or pointed out by the reference. In one embodiment, when the reference contains an URL, the corresponding Webpage may be refreshed, e.g., using one or more default values of the report parameters of the Webpage. Thus, the most recent information will be presented. If the reference includes a pointer to one or more report parameters stored in the computer system, the associated data report may be generated and executed based on the report parameters, e.g., based on the current or the default values of the report parameters. For example, the set of report parameters may specify one or more data sources, one or more data queries, one or more output forms, etc.

At 335, access to the executed data report is provided, according to one embodiment, where the report contains current data associated with the reference stored in the code image. The current data may be exposed directly on a screen coupled to the smart device used to pick up the code image. In one embodiment, the current data may be sent to one or more alternative or parallel outputs as well. For example, the result of the execution of the data report may be sent to a device that is different from the smart device used to scan the code image. The alternative output may be predefined for the requested report, or it may be specified in the request. The examples for alternative or parallel outputs may include, but are not limited to a computer system different from the smart device, printer, email address, etc.

In one embodiment, the access to the result of the execution of the data report provided at 335 may also include access to functionality to modify the data report. For example, a user may be interested in changing the values of the report parameters to extend or drilldown the received information. Such functionality may be provided on a Webpage with the help of links, filters, searches, selectable menu items, etc. The Webpages containing the requested data reports may be appointed by the reference in the code image, or it may be generated based on the report parameters referenced or included in the code image to display the extracted data. In one embodiment, the functionality available for modification of the report parameters may be provided through the same application used to read the reference from the scanned image. At 340, a check is performed to verify whether there are any modifications made to the report parameters. If such modification has been made, process 300 loops back to 330 to executing data report based on the modified set of parameters.

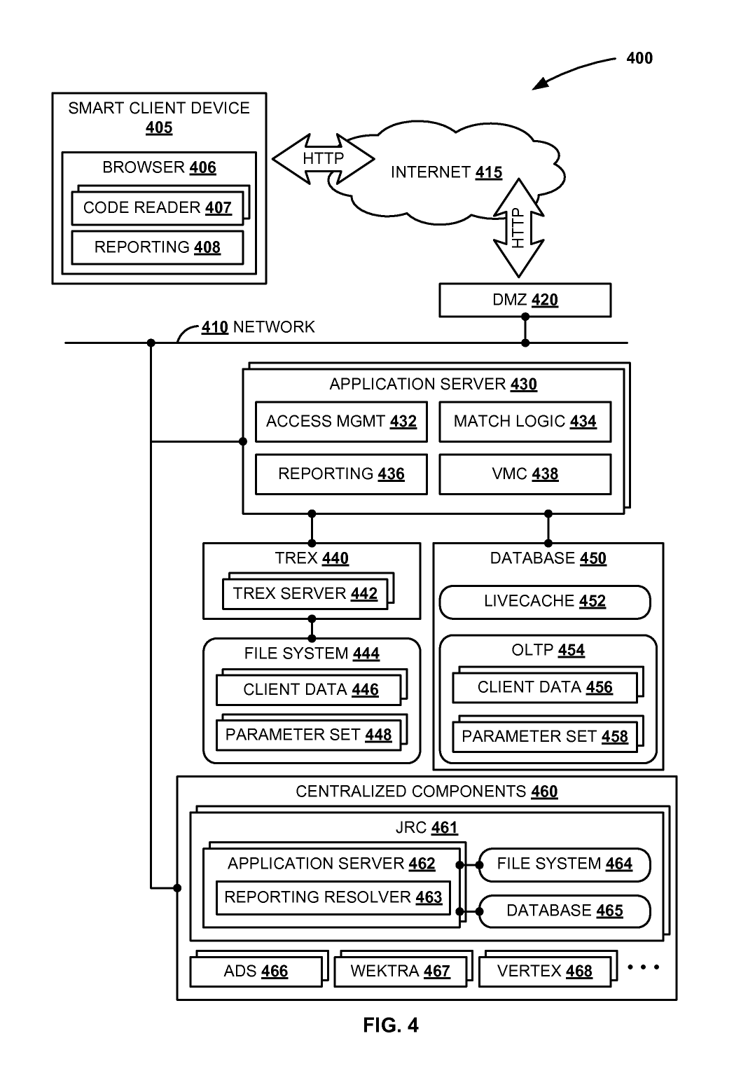

FIG. 4 shows computer system landscape 400 where an exemplary solution for accessing current data by using code images is implemented, according to one embodiment. Some of the modules of the computer system landscape 400 resemble products or systems developed by the company SAP AG. However, a practitioner in the field of computer systems would recognize that modules with similar functionality developed by other companies may be used to achieve analogous results. Further, the illustrated computer system landscape 400 is based on the architecture of Business ByDesign® service provided by SAP AG. Many of the elements required in Business ByDesign® are not illustrated since they are not directly involved in the presented exemplary solution. However different embodiments may involve different modules of Business ByDesign® or of other system landscape architectures.

The presented computer system landscape 400 includes smart client device 405. Practically, any computer system, e.g., personal computer, laptop, tablet, smartphone, etc., could be configured to serve as the smart client device 405. In one embodiment, the smart client device 405 includes browser application 406, e.g., Internet browser enhanced with plug-in functionality to provide access to various business related services, including reporting. For example, the browser 406 may be enhanced with Microsoft ® Silverlight® plug-in developed by Microsoft Corporation as to provide runtime environment for Microsoft® Silverlight® rich Internet applications. In one embodiment, the smart client device 405 may include at least one of code image reader application 407 and reporting application 408 dedicated to access current data by using code images.

Either the code image reader application 407 or the reporting application 408 may be developed to run in a runtime environment provided by the browser 406. In one embodiment, browser 406 may open Webpages containing updated data reports by using URLs read from code images. The dedicated reporting application 408 may provide direct access to a backend reporting system based on references included in code images. In one embodiment, the dedicated reporting application 408 may render direct access through a browser interface, e.g., provided by browser 406. The references may be read from the code images directly by the dedicated reporting application 408, or, the reporting application may use the services of different code reader applications 407 for different types of code images and/or technologies to retrieve references. The smart client device 405 may capture various code images depending on its built-in capabilities or peripherals (e.g., camera, scanner, radio antenna, infrared port, microphone, etc.)

In one embodiment, the smart client device 405 is connected to one or more backend computer system environments via the Internet 415, e.g. over HTTP. The one or more backend computer system environments may provide various services to the smart client device 405, e.g., to be consumed by the user or users of the smart client device 405. For example, application servers 430 may provide reporting services to the smart client device. In one embodiment, the computer system backend may include more than one application server nodes 430. In one embodiment, application servers 430 are ABAP® application servers, e.g. used based on the Advanced Business Application Programming (ABAP) technology of the company SAP AG.

Application servers 430 may connect to the Internet 415 via internal network 410 (e.g., intranet) and through demilitarized zone (DMZ) 420, as illustrated in FIG. 4. In one embodiment, the DMZ 420 is a logical sub-network where the services provided by the backend system (e.g., by the application servers 430) are exposed. The DMZ 420 may apply various protection mechanisms against malicious service requests or virus attacks coming from the Internet 415. Further, a hardware load balancer and/or Web dispatcher (not illustrated) may operate within the DMZ 420 to route the incoming service requests to separate application servers 430, e.g., depending on the available functionality or/and on the current load. In one embodiment, the separate application servers 430 have similar configuration and functionality, and may operate as a cluster of server nodes.

In one embodiment, the functionality of application server 430 is enhanced to include access management application 432 to control whether the smart client device 405 and/or the user operating it have the rights to access the requested data. For example, the access management application 432 may check whether the smart client device 405, or another device declared as an output channel for the current data has the necessary functionality. The access management application 432 checks user credentials and authorizations to access and drilldown data based on code images as requested. The access management 432 may not be developed as a separate application, but rather, like an extension of an existing functionality or mechanism. In one embodiment, the access management functionality may be provided as a service to the application server 430.

Matching logic 434 could be described as functionality helping the application servers 430 to identify sets of reporting parameters based on references extracted from code images. The matching logic 434 may receive a reference from the smart client device 405, based on the information the reference provides, to trigger a corresponding process. For example, one or more specific Webpages may be generated and sent back to smart client device for display when the reference contains one or more URLs. When the reference contains a pointer to a set of report parameters, the matching logic 434 may call specific methods for information lookup in a database where the reporting parameters are stored. Other actions corresponding to the type of the received reference may be triggered by the matching logic 434.

Reporting 436 is an application or functionality handling the generation and execution of data reports based on predefined requirements or sets of report parameters, according to one embodiment. The dedicated reporting application 408 in the smart client device 405 may directly access or interface with the reporting application 436 at application server 430. The reporting functionality 436 at application server 430 may serve data requests sent by other applications as well, including internal and external applications, e.g., browser 406, matching logic 434, etc. The reporting 436 may format and send the results of a data report to the smart client device, or to another alternative or parallel output channel, where the data report is executed based on report parameters associated with a code image received from the smart client device 405.

In one embodiment, one or more of the access management 432, matching logic 434, reporting 436 applications or functionalities are developed with the means provided by the ABAP® technology, e.g., ABAP® applications. Alternatively, one or more of these applications may be based on Java®, a programming language and server platform technology developed initially by the company Sun Microsystems Inc. (now owned by the company Oracle Corporation). The Java® based applications in the ABAP® application servers 430 are executed in Virtual Machine Container (VMC) 438 provided to allow Java® based applications to be executed with a similar level of robustness as software developed in ABAP® on application servers 430. In one embodiment, VMC 438 is part of NetWeaver® platform developed by the company SAP AG.

In one embodiment, applications servers 430 communicate with database 450 to store and extract data. Respectively, the database 450 is used as a primary storage for parameter sets 458 defining one or more data reports that could be referenced by code images. The database 450 may be designed, organized and managed based on the Online Transaction Processing (OLTP) methodology to support business transactions. Thus, client data 456, parameter sets 458, etc., may be accessed and manipulated using various database transactions, e.g. generated by the business and reporting applications running in the application servers 430.

Despite its suitability to support business transactions, the OLTP methodology applied in database 450 may slow down the overall reporting performance. Therefore, different solutions help speed-up the access to requested business data. For example, the database 450 may provide liveCache® database instance to access data. The liveCache® database instance may be used to make large volumes of data permanently available and changeable, e.g., to support access to current data based on code images, according to one embodiment. For this reason, an addition could be made to the OLTP based relational database 454 in database system 450 to enable actual data structures and data flows (such as networks and relationships) to be mapped more easily and effectively. This product is called liveCache®. The liveCache® could be object-oriented application, and, unlike the OLTP database 454, may operate with its data only in the main memory of the database system 450, if configured optimally.

In one embodiment, various information, including client data 446 could be stored in file system 444 of the backend environment. The information stored in file system 444 may be accessed by application servers 430 using Text Retrieval and Information Extraction (TREX) system 440. The TREX system 440 may include one or more TREX servers 442 (e.g., clustered) to run central SAP NetWeaver® search engine that provides underlying search technology and functions. TREX services provided by the TREX system 440 include search and retrieval in large document collections, text mining and automatic document classification. In one embodiment, the file system 444 accessed by the TREX system 440 may be used as secondary storage of reports and report parameters for performance optimization. In one embodiment, database system 450 and/or TREX system 440 may implement column based data structures, e.g., available in-memory for fast access.

In one embodiment, the functionalities and applications running on application servers 430 may use various components provided as centralized components 460 by a number of systems available at the backend computer system environment. The systems providing centralized components may include, but are not limited to Java® Reporting Component (JRC) systems 461, Adobe Document Services (ADS) systems 466 (to enhance the document handling capabilities, e.g., of the application server 430), WEKTRA systems 467 (providing SAP Business ByDesign® help, built-in learning and community components), Vertex systems 468 (providing tax calculation components, e.g., for integration of different tax systems), etc.

The JRC systems 461 enable embedding report viewing and exporting into Web applications. For example, the JRC 461 provide Java® viewers, which are a collection of Java® classes that can be used to generate HTML and Dynamic HTML pages to display and export report data. In one embodiment, the components provided by the JRC systems 461 may be used to create reporting applications, e.g., embedded directly into JavaServer® Pages (JSP). The JRC systems 461 include one or more application servers 462 (e.g., Java® Application Server (Java AS®)) processing information stored in local file system 464 and/or database 465. In one embodiment, the JRC systems 461 may be enhanced with reporting resolver functionality or module 463 to resolve sets of reporting parameters included or appointed by references stored in code images to generate and expose relevant data reports.

In one embodiment, application servers 430 provide functionality to create a unique identification (ID), e.g., global unique ID (GUID), associated with a generated data report (e.g., form, Web page, etc.). The created GUID may be stored (e.g., in the database 450) as a reference to the data report, and/or to the report parameters characterizing the data report. For example, the application servers 430 may use components provided by JRC systems 461 to generate such unique references. Further, a code image containing the created reference may be generated (e.g., by specialized applications or services available at the backend landscape). The code image may be used to augment a document (e.g., managed by components of the ADS systems 466). The document could be printed out or electronically transmitted to a consumer, according to one embodiment.

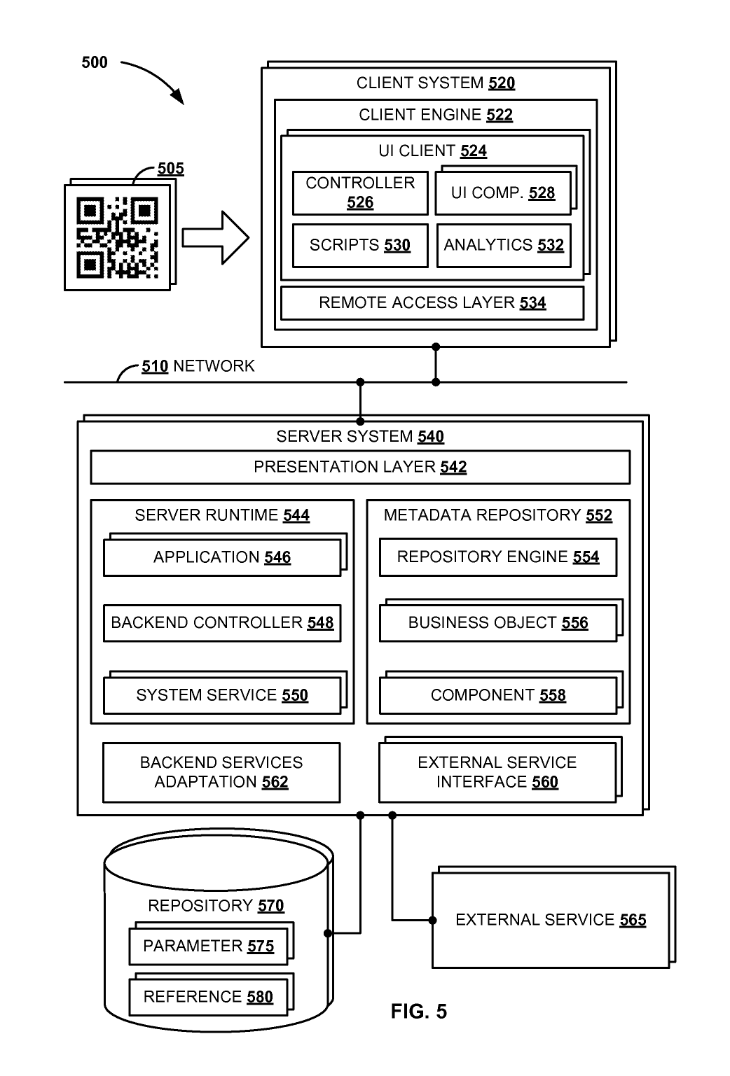

FIG. 5 is a block diagram showing computer system landscape 500 where access to current data using code images is implemented, according to one embodiment. The computer system landscape 500 includes a rather simplified example of classic client-server architecture. Users may request different services or execute various operations available within client systems 520, or provided by one or more server systems 540 via network 510. The illustrated server systems 540 represent one or more backend nodes in the computer system landscape 500. In one embodiment, one or more code images 505 are captured at the one or more client systems 520. Based on the content of the information stored in the code image, different services may be provided to the users of the client systems 520, including access to up-to-date data reports.

The client systems 520 and the server system nodes 540 communicating via network 510 may define a number of different computer system environments. Network 510 may represent public or private computer network, or a combination of public and private computer network segments. Some of the elements of the computer system landscape 500 resemble the structure and functionality of software modules developed by SAP AG. However, structures with similar functionalities could be found in software products developed by other vendors, as well. Alternative embodiments may utilize other kinds of computer system architectures.

The involved client systems 520 may have similar or different structures where one or more of the illustrated modules are replicated. One or more users may operate within one or more instances of user interface (UI) client 524 of one or more of client systems 520. Different users may exclusively access different instances of the UI client 524 within a same client system 520.

In one embodiment, any of client systems 520 may execute a standalone client application, e.g., client engine 522, to interact with the backend server system 540. Alternatively, an intermediate layer may be downloaded to any of the client systems 520 as an extension of a running Internet browser. Such intermediate layer may be also illustrated as client engine 522. The standalone client application and the intermediate layer may have similar components and functionality. Client engine 522 takes responsibility for rendering the necessary client functionality, and also for communicating with server systems 540 via network 510 when necessary.

The client engine 522 includes UI client instances or sessions 524 that may also embed into a browser integrated framework. The UI client 524 may be a part of any popular browser integrated framework, e.g. Silverlight® provided by Microsoft Corp, Flex® provided by Adobe Systems Inc., JavaFX® originally developed by Sun Microsystems Inc., etc. In one embodiment, the client engine 522 and UI client 524, respectively, may be desktop application, for example, a .NET® application rendering a UI through a Windows Presentation Foundation (WPF) system. The UI client 524 accesses the necessary business data at the backend 540 through remote access layer 534 via network 510. In one embodiment, no dedicated UI server or client programs are needed. The communication with the backend 540 may include extracting, storing and updating data. The data may be transported to repositories 570, especially when backend 540 implements a number of server nodes in separate computer system environments.

In one embodiment, the users of the client systems 520 generate services requests at UI client 524 either manually or automatically, e.g., by picking up code images. UI components module 528 instantiates one or more appropriate graphical user interface (GUI) screens or controls in response to the user requests. The behavior of the UI components is managed by controller 526. The controller 526 makes sure that all instantiated controls in the UI components 528 are initialized. The controller is also responsible for the execution of any configured operation triggered by events corresponding to the instantiated controls. In case when some of the operations involve execution of script segments, the controller 526 may trigger the execution of these scripts via scripts module 530. In one embodiment, scripts module 530 is a frontend scripting engine. Analytics module 532 may be used for frontend data processing when necessary.

In one embodiment, the backend 540 utilizes presentation layer 542 to connect to the Internet and/or to other public or private networks, and to provide access for the UI client sessions 524 to underlying business functions and data structures. For example, the presentation layer 542 may generate the UI object model underlying the UI controls instantiated in the UI components module 528 at the client systems 520. In one embodiment, presentation layer 542 may be part of the server runtime 544.

The server runtime 544 provides environment where one or more software applications 546 are executed. For example, the applications 546 may provide a number of business and/or reporting services for the users of client systems 520, where various requests are translated to corresponding process tasks performed by the applications 546, executed in server runtime 544. For example, a reporting application 546 may process requests to access current data based on references extracted from the code images 505.

In one embodiment, the server runtime 544 includes backend controller 548 for one or more UI client sessions 524 to handle the requested UI components 528, e.g., when a UI client session 524 triggers an initialization of a UI component for the first time. The backend controller 548 may manage the collaboration between the requested UI components 528 and one or more underlying business or data objects. System services 550 in the server runtime 544 may be used to administer the characteristics of the server runtime 544, e.g., its engine parameters, the user access to one or more components, the processes execution, the communication with other runtime environments, like, external systems, databases, etc. In one embodiment, system services 550 may also provide deployment, setup and change management of software components.

Metadata repository 552 is generally the place where metadata about the computer programs deployed in the server system 540 are preserved, according to one embodiment. There are different kinds of metadata that could be maintained by the metadata repository 552. For example, the repository 552 keeps the description of the business objects 556 underlying the applications 546. In one embodiment, metadata repository 552 keeps description of the available program components 558 (e.g., including UI components) and the relationships between them as designed.

Repository engine 554 manages the metadata and the collaboration with the server runtime 544 at one hand, and with various service providers 565 at the other hand. The service providers 565 may render services and/or corresponding components to the backend 540 as defined in the metadata. The service providers 565 are available via service provider interfaces 560, and can be either internal or external to the backend 540. In one embodiment, backend services adaptation 562 represents a layer that helps to adjust the designed or rendered components to a set of normalized business objects available at the server system 540.

In a multi-server system environment, e.g., in a cluster of more than one server system nodes 540, repositories 570 may be used to persist different kinds of common data, including programming code, business data, metadata, etc. In one embodiment, one or more different repositories 570 may be assigned to different computer system environments defined in the computer system landscape 500.

In one embodiment, the users of client systems 520 may design, create or change a program component, a business or data object, a data report or some other type of artifact in the computer system landscape 500 by manipulating UI components 528 associated with particular application or software tool. The UI components 528 may be available within GUI environment of the UI client 524. The manipulations of the UI components 528 may trigger execution of various system or application procedures in server runtime 544. Further, the manipulations of the UI components 528 may lead to changes in the metadata repository 552, e.g., changes in the definitions of the components 558, even to changes in the descriptions of the business objects 556, etc.

For example, by manipulating UI components 528 or by directly entering program code, a user may create a data report artifact in development computer system environment defined in the landscape 500. The parameters of the data report could be stored as artifact among other parameters 575 in repository 570. Further, a reference pointing to the data report or to the parameters of the report, or containing the parameters, could be also stored in repository 570 among other references 580. In one embodiment, the different environments in the landscape 500 could be logically and even physically isolated, where each computer system environment may encompass separate server system nodes 540, different repositories 570 and even different client systems 520.

In one embodiment, based on the created data report reference, a code image may be generated, e.g., by functionality provided by applications 546 or by using external service 565. The generated code image may be used to augment the results of the created data report. For example, the code image may be printed next to the printed results of the data report. The same code image then may be captured as code image 505 by the client system 520. Thus, based on the stored reference, users of the client system 520 with sufficient privileges may receive direct and time saving access to the most current data related to the report parameters. The users may use the functionality of the client engine 522 to further analyze and/or drill down the data relevant to the data report. In one embodiment, the code image has to be transported from the computer system environment where it was created to a computer system environment where it will be used to augment a document, e.g., printing service.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

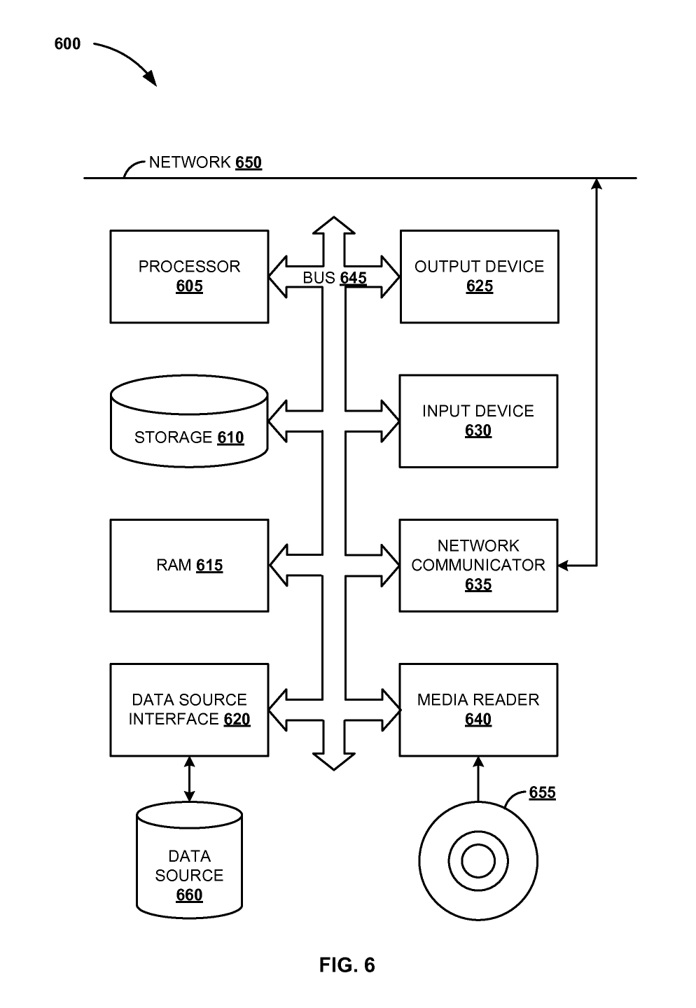

FIG. 6 is a block diagram of an exemplary computer system 600. The computer system 600 includes a processor 605 that executes software instructions or code stored on a computer readable storage medium 655 to perform the above-illustrated methods. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed via network 650. In some embodiments the data source 660 may be accessed by an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the presented embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limiting to the precise forms disclosed. While specific embodiments and examples are described herein for illustrative purposes, various equivalent modifications are possible, as those skilled in the relevant art will recognize. These modifications can be made in light of the above detailed description. Rather, the scope of the specification is to be determined by the following claims, which are to be interpreted in accordance with established doctrines of claim construction.

What is claimed is:

1. A computer system to access data by using code images, the system comprising:
a memory to store computer executable instructions; and
a processor coupled to the memory and operable to execute the instructions to generate:
a first data report based on a plurality of report parameters,
a unique reference to at least one report parameter of the plurality of report parameters,
a code image scannable by a smart device, wherein the code image contains the unique reference, and
a document, wherein the code image is embedded into the document.

2. The system of claim 1, wherein the unique reference includes one or more of the at least one report parameter and at least one value corresponding to the at least one parameter.

3. The system of claim 1, wherein the document includes at least partial result set of first execution of the first data report.

4. The system of claim 1, wherein the processor coupled to the memory is operable to execute the instructions stored in the memory further to generate:
a result set of second execution of the first data report in response to receiving the unique reference from a smart device.

5. The system of claim 1, wherein the processor coupled to the memory is operable to execute the instructions stored in the memory further to generate:
a result set of second execution of the first data report based on a modified value associated with the at least one report parameter, wherein the second execution of the first data report is in response to receiving the unique reference from a smart device.

6. The system of claim 1, wherein the processor coupled to the memory is operable to execute the instructions stored in the memory further to generate:
a second data report based on a modification of the at least one report parameter, wherein the second data report is generated in response to receiving the unique reference from a smart device.

7. A non-transitory computer-readable medium storing instructions, which when executed cause a computer system to:
create a data report based on a plurality of report parameters;
generate a unique reference to at least one report parameter of the plurality of report parameters;
execute the data report in response to receiving the unique reference from a smart device; and
send a result of the executed data report to at least one indicated output.

8. The computer-readable medium of claim 7, wherein generating the unique reference to the at least one report parameter comprises:
including one or more of the at least one report parameter and at least one value corresponding to the at least one parameter in the unique reference.

9. The computer-readable medium of claim 7, wherein executing the data report in response to receiving the unique reference comprises:
receiving a scanned copy of a code image; and
extracting the unique reference to the at least one report parameter from the code image.

10. The computer-readable medium of claim 7, wherein executing the data report comprises:
receiving user credentials from the smart device; and
executing the data report in response to receiving the unique reference from the smart device when an authorization to access reported data is confirmed based on the received credentials.

11. The computer-readable medium of claim 7 storing instructions, which when executed cause the computer system further to:
receive at least one new value associated with the at least one report parameter; and
execute the data report based on the at least one new value associated with the at least one report parameter.

12. The computer-readable medium of claim 7 storing instructions, which when executed cause the computer system further to:
receive a modification of the at least one report parameter; and
create a modified data report based on the modified at least one report parameter.

13. A computer implemented method of accessing current data, the method comprising:
receiving, at a memory of a computer system, a reference to at least one report parameter, wherein the reference is extracted from a code image;
executing, by a processor of the computer system, a data report based on the at least one report parameter; and
sending, over a computer network, a result of the executed data report to at least one indicated output.

14. The method of claim 13, wherein receiving the reference to the at least one report parameter comprises:
receiving a scanned copy of the code image; and
extracting the reference to the at least one report parameter from the code image.

15. The method of claim 13, wherein receiving the reference to the at least one report parameter comprises the at least one report parameter.

16. The method of claim 13, wherein receiving the reference to the at least one report parameter comprises:
receiving at least one value associated with the at least one report parameter.

17. The method of claim 13, wherein executing the data report comprises:
creating the data report based on the at least one report parameter.

18. The method of claim 13 further comprising:
receiving at least one new value associated with the at least one report parameter; and
executing the data report based on the at least one new value associated with the at least one report parameter.

19. The method of claim 13 further comprising:
receiving a modification of the at least one report parameter; and
creating a modified data report based on the modified at least one report parameter.

20. The method of claim 19 further comprising:
generating a unique reference to the modified at least one report parameter; and
generating a code image scannable by a smart device, wherein the code image contains the unique reference.
